(19) United States
(12) Patent Application Publication
(10) Pub. No.: US 2017/0017360 A1
(43) Pub. Date: Jan. 19, 2017

(54) METHOD FOR CHECKING NETWORK ELEMENTS AND NETWORK

(71) Applicant: SIEMENS AKTIENGESELLSCHAFT, MÜNCHEN (DE)

(72) Inventors: MICHAEL KIRCHNER, MÜNCHEN (DE); BENEDIKT VAMOS, NEUBIBERG (DE)

(21) Appl. No.: 15/206,370

(22) Filed: Jul. 11, 2016

(30) Foreign Application Priority Data
Jul. 17, 2015 (DE) 102015213463.6

(51) Int. Cl. G06F 3/0482; G06F 3/0484; G06F 3/14; H04L 29/08

(52) U.S. Cl. CPC G06F 3/0482; H04L 67/02; G06F 3/04845; G06F 3/14

(57) ABSTRACT

A method for checking network elements in a network is provided. The respective network element can be activated with the aid of a web interface and has a network address. The method includes the steps: calling up the web interfaces with the aid of the network addresses; generating an image record for each web interface called up, the image record including a graphical representation of the web interface on a display device; ordering the web interfaces called up in groups, the graphical representations on the display device of the web interfaces allocated to a respective group having a graphical measure of similarity and the graphical measure of similarity being determined with the aid of the respective image record; and displaying the graphical representations of the web interfaces of at least one of the groups on a screen having a screen surface.

### CROSS-REFERENCE TO RELATED APPLICATIONS

This application claims priority to DE Application No. 102015213463.6, having a filing date of Jul. 17, 2015, the entire contents of which are hereby incorporated by reference.

### FIELD OF TECHNOLOGY

The following relates to a method for checking network elements in a network and to a network.

### BACKGROUND

Frequently, the infrastructure of a network, particularly of network elements of the network, is examined as part of a security analysis or of a stock take. Depending on the characteristics and type of the network elements, one is confronted by several different web interfaces, graphic user interfaces of the respective network elements.

The network elements are usually checked by manually calling up the individual web interfaces. However, a large part of the web interfaces is of no importance to a security analysis or stock take so that their call up, loading and displaying on a display device, e.g. on a screen, represents a loss of time, costs and effort.

### SUMMARY

An aspect relates to improving the checking of network elements in a network.

Accordingly, a method for checking network elements in a network is proposed.

The network elements can be activated with the aid of a respective web interface and have a respective network address. The method comprises the steps:
calling up the web interfaces with the aid of the network addresses;
generating an image record for each web interface called up, the image record comprising a graphical representation of the web interface on a display device;
ordering the web interfaces called up in groups, the graphical representations of the web interfaces allocated to the respective group exhibiting a graphical measure of similarity on the display device, and the graphical measure of similarity being determined with the aid of the respective image record; and
displaying the graphical representation of the web interfaces of at least one of the groups on a screen having a screen surface.

The graphical representations of the web interfaces are displayed scaled down in such a manner that the graphical representations of the web interfaces of a group are displayed together inside the screen surface on the screen.

In particular, several different network elements are concerned which have in each case a network address. To this extent, it can be called a method for checking several different network elements in a network. The network elements, therefore, also have different network addresses.

Optionally, the method proposed also comprises the step:
checking the network elements with the aid of the displayed graphical representation of the web interfaces belonging to the network elements.

The network elements are interconnected with one another, i.e. coupled and/or electrically connected, at least partially in such a manner that they can transmit information, commands and/or data to one another. The network elements can preferably process electrical signals actively and/or passively, i.e. the network elements can comprise active network components. The network elements are preferably connected to a power supply which supplies them with an electric power necessary for proper operation.

The network elements can comprise autonomous systems, e.g. computers, printers, control units, field devices and the like. In particular, the network elements comprise devices, machines and/or electric systems which are at least partially automated, i.e. need no or a reduced human intervention for their operation. The network elements can be part of an autonomous system, e.g. of a computer.

In particular, the network elements are configured to transmit data with the aid of a network-internal network protocol. The network protocol can comprise TCP/IP, UDP, IPX/SPX, NetBEUI, AppleTalk, BACnet, etc. In particular, the network protocol comprises HTTP, UDS, FTP, SMTP, POP, Telnet, OPC UA, SOCKS, TCP, UDP, SCTP, IP, ICMP, Ethernet, Token Bus, Token Ring, FDDI and/or IPoAC. In particular, the network addresses are IP addresses of the network elements.

The web interface relates especially to an interface, preferably a graphical user interface, to a network element. In particular, with the aid of the web interface, functions of the respective network element can be executed and/or the functions can be accessed. The web interface can be called up, in particular, via the Hypertext Transfer Protocol (HTTP). The web interface can comprise, in particular, a graphical user interface (GUI) and/or a web service.

The graphical user interface is represented graphically on a screen preferably with the aid of a display device. The display device relates, in particular, to a window and/or a browser element which can be displayed on a screen. Furthermore, the display device can relate to an imaging environment in a computing unit which can reproduce the graphical representation of the web interface with the aid of source codes which are provided by the respective network element. In this context, the screen can be related to some electronic device which can represent an electronic signal optically. For example, the screen comprises a monitor, a display device, a projection device or any other electrical display device. The graphical user interface, in particular, provides for an interaction with the respective network element, e.g. inputting of commands, calling up information, changing or adjusting configuration and modifications.

The network elements can communicate with one another, e.g. provide data or functions for one another, with the aid of the web service. An example of a web interface is an integrated web server of a network element via which the user can perform changes in the configuration of the network element. The web interface is preferably platform-independent, i.e. independent of an operating system of the respective network element.

Via the web interface, the network element can be activated, operated, modified and/or configured. The web interface comprises, in particular, a graphical representation on a display device. The graphical representation can contain text elements (e.g. characters and numbers), images, colors, color combinations, hyperlinks and/or markings. In particular, the web interface can comprise marked areas for an input of commands for the network element. The text elements can reproduce information, e.g. a version number of firmware, via the respective network element.

Preferably, each network element of the network has a network address allocated to it. The allocation of the network addresses to the network elements is preferably unambiguous, i.e. a network element can have one network address at the most and a network address can be allocated to one network element at the most. The network address is preferably suitable for unambiguous identification of the respective network element. It is conceivable that the network address which is allocated to a particular network element can be released again in that a further network address is allocated to the particular network element.

The network elements can be addressed with the aid of the network addresses and as a response, the web interface of the respective network element can be reproduced. The network addresses can be present in the form of a table. Alternatively or additionally, a computing unit and/or server device, which are coupled to the network, can provide a table with the network elements and the respective allocated network addresses.

The web interfaces are preferably graphically representable on a display device. The graphical representation of the individual web interfaces can be stored electronically in the form of the respective image record. With the aid of the stored image record, the graphical representation of the respective web interface can be preferably generated. An image record is, in particular, an electronic file and/or relates to content in an electronic file. For example, the graphical representation of the respective web interface can be generated by means of color values, e.g. in a CMYK color space, RGB color space or Lab color space which are allocated to each dot, e.g. a pixel, of a screen and/or a display device on a screen. The image record can accordingly comprise the color values allocated to the pixels. The image record is generated and/or stored, for example, with the aid of a descriptive language, e.g. HTML. The graphical representation of the web interface can be generated on the basis of the respective image record. In this context, the graphical representation can be generated by a server device, a network element and/or a computing unit.

The graphical measure of similarity preferably specifies how many commonalities the graphical representation of a particular web interface has with the graphical representations of other web interfaces. The graphical measure of similarity can be an absolute or relational quantity and, e.g., have a scalar, a vector, a matrix and/or an array. For example, a correlation parameter and/or a measure of proximity of the web interfaces can be calculated which mathematically covers the commonalities of the graphical representations of in each case two web interfaces and reproduces them as a one-dimensional quantity. In particular, the graphical measure of similarity is determined in that the image record of the individual web interfaces is evaluated.

For determining the graphical measure of similarity and/or for ordering the web interfaces in groups, an image clustering process and/or a cluster analysis is preferably performed. For example, a “structural similarity index” (SSIM), a “mean squared error” (MSE), a “K-means”, a “C-Means” and/or a “Gaussian maximum likelihood classification” (GMLC) is applied to group (i.e. “clustering”) the image records of the web interfaces called up and thus to order the called-up web interfaces in groups.

The graphical measure of similarity can be determined with the aid of a pixel-oriented, edge-oriented, region-oriented, model-based and/or texture-oriented method or a combination thereof.

A similarity of web interfaces is determined by the graphical measure of similarity of the respective graphical representations of the corresponding web interfaces. The web interfaces called up are allocated to a common group when their graphical measure of similarity exceeds a predetermined threshold value. A group of web interfaces can point to particular characteristics of the network elements which have the web interfaces of the group of web interfaces.

The graphical representations of the web interfaces can be displayed on a display device, e.g. a window or a browser device, on the screen. The screen surface of the screen has predetermined screen dimensions which can be defined by a specification of pixel numbers for each direction, e.g. height×width.

The graphical representations of the web interfaces arranged in groups can have in each case image dimensions which are smaller by a multiple than the screen dimensions of the screen surface. By this means, several graphical representations can be displayed simultaneously on the screen. The graphical representations of the web interfaces which are allocated to a common group can have identical or different image dimensions.

By means of the proposed method, the graphical representations of the web interfaces are shown on the screen in such a manner that the graphical representations of similar web interfaces can be displayed grouped. By this means, for example, a so-called “false-positive”, i.e. a web interface which is allocated falsely to the group, can be identified more rapidly rather than having to check the graphical representations individually. In addition, the reproduction of the graphical representations of the web interfaces called up is accelerated since the web interfaces are not loaded individually for display on the screen but only their graphical representations are reproduced on the basis of the respective image record. Furthermore, it is possible to save a loading time which is required for transferring data for generating the respective graphical representation of the web interfaces called up.

According to one embodiment, the graphical representations of the web interfaces which are allocated to different groups are displayed spaced apart on the display device in dependence on the measure of similarity.

The graphical representations of web interfaces which are allocated to a common group on the basis of their similarity based on the measure of similarity are preferably shown grouped on the screen. Furthermore, the graphical representations of the web interfaces called up, which are similar to one another and allocated to different groups of web interfaces can be displayed arranged close to one another on the screen. Correspondingly, the graphical representations of two groups of web interfaces which are not very similar can be arranged far distant from one another.

In this context, the term “similar” can refer to the measure of similarity of the graphical representations of web interfaces which exceeds a predetermined threshold value.

This provides for a faster acquisition of similar graphical representations of web interfaces without individual calling-up of the web interfaces being needed. As a result, network elements which are irrelevant to a check or require special attention can be detected more rapidly.

According to a further embodiment, the graphical representations of the web interfaces on the screen are provided with a respective hyperlink by means of which the respective web interface can be called up.

If an irregularity, a security gap, a potential risk and/or a requirement for a check are found in one or more graphical representations of the web interfaces, the respective network element can be rapidly accessed with the aid of the respective hyperlink. The hyperlinks can be provided, in particular, with the aid of a network address list. This provides for rapid accessing of the respective network element which is to be checked.

According to a further embodiment, the network comprises a computer network, an intranet and/or an Internet with a network protocol.

The network comprises several mutually interconnected network elements. A number of network elements in a network is at least two and is preferably not limited. For example, the network can comprise at least a part of the Internet. In a further example, the network can comprise an internal network, i.e. the intranet, of an enterprise.

According to a further embodiment, the network elements comprise machines, devices, EDP devices, computers, printers, server devices, routers, switches, bridges, firewalls and/or session border controllers.

The network elements can be part of a computer network. The network elements can comprise active and/or passive network components. The network elements can preferably extract information from a received and/or measured electric signal. Furthermore, the network elements can preferably prepare information for a transmission from an information source to an information user.

According to a further embodiment, the network also has at least one further network element without respective web interface.

The network can comprise network elements which are interconnected with other network elements of the network and do not have an allocated web interface. When the network elements without allocated web interface are addressed, an error message may be reproduced which can be stored in the form of an image record and the graphical representation of which can be displayed on the screen. Alternatively or additionally, a list of network elements without allocated web interface can be generated.

According to a further embodiment, the respective image record is stored in a bit map format.

In particular, the respective image record is stored as raster graphics. The bit map format comprises a raster-shaped arrangement of pixels, i.e. pixels to which color values are allocated in each case, as described above. The bit map format comprises especially the image dimensions and the color values of the respective image record. For example, the respective image record is generated and/or stored in an APX, BMP, GBR, GIF, JPEG, PBM, PGF, PGM, PNG, PPM, TIFF, XBM and/or XCF format.

Alternatively or additionally, the respective image record can be stored as vector graphics.

According to a further embodiment, the method also comprises the step:
executing a pattern recognition method with the graphical representations of the web interfaces.

The pattern recognition method can recognize, in particular, regularities, repetitions, similarities and/or legalities in the graphical representations of the web interfaces called up. In particular, the pattern recognition method is suitable to determine the measure of similarity of the graphical representations of the web interfaces.

By this means, the checking of the graphical representations of the web interfaces called up can take place in an automated and rapid manner.

According to a further embodiment, the groups of web interfaces are identified with the aid of a discoloration compared with a background color and/or border on the screen.

The screen surface of the screen can have a uniform background color. The groups of web interfaces can be underlaid, for example, with a color which differs from the background color of the screen.

Alternatively or additionally, the groups of web interfaces can be bordered with a line or something else. In this manner, the groups of web interfaces can be made visually identifiable in the graphical representations.

A respective size of the border and/or of a discolored area of a group of web interfaces can be varied in dependence on a number of web interfaces in the group of web interfaces. For example, the size of the border and/or of the discolored area of a group increases when the number of web interfaces increases in this group.

For example, the screen has a black background color whereas the groups of web interfaces are bordered and an area within a border around each group of web interfaces is white. The border can be designed in the form of a black, white or colored line.

According to a further embodiment, the method also comprises the step: optical checking of at least one of the groups of web interfaces, the graphical representations of which are displayed on the screen.

The optical checking relates especially to checking the graphical representations of the web interfaces which are allocated to a common group of web interfaces. The optical checking comprises, for example, detecting a version number of the respective web interface, detecting a potential security risk and detecting a security gap. In particular, the checking can comprise accessing at least one of the network elements with the aid of a respective hyperlink.

According to a further embodiment, the method also comprises the step: masking out of an optically checked group of web interfaces.

By masking out one or more groups of web interfaces already checked, an improved clarity can be created on the screen.

According to a further embodiment, the graphical representations of the web interfaces contain characters, patterns, images and/or areas of colors different from one another.

According to a further embodiment, the method also comprises the step:
changing a size of the graphical representation of at least one of the web interfaces on the screen, the size of the graphical representation being determined by a number of pixels comprised by the graphical representations on the screen.

For example, a number of pixels along each axis of the graphical representation of the web interface specifies how large the graphical representation is. The size of the graphical representations of the web interfaces can be varied in that the number of pixels is reduced or enlarged and the color values are interpolated and/or approximated.

According to a further embodiment, several groups of web interfaces, the respective measure of similarity of which is higher than a threshold value for the measure of similarity, are displayed in an overlapping manner.

This makes it possible to emphasize and recognize at first glance which groups of web interfaces are particularly similar to one another. The overlapping of groups can be related to borders and/or discolored areas of the groups touching and/or flowing together. In particular, two groups can be similar to one another in such a manner that a distance between the two groups is smaller than a size of one of these two groups so that the two groups are arranged to overlap. In this context, the size of the group can be related to the area contained by the border and/or the discolored area of the group.

According to a second aspect, a network having a number of network elements is proposed. The network is suited to execute the method proposed.

According to a further embodiment, a computing unit coupled with the network is provided. The computing unit is configured for executing the proposed method.

The respective unit, for example the computing unit, can be implemented in hardware and/or also in software. In the case of a hardware implementation, the respective unit can be designed as device or as part of a device, for example as computer or as microprocessor or as mobile computing unit. In the case of a software implementation, the respective unit can be designed as computer program product, as a function, as a routine, as part of a program code or as executable object.

Furthermore, a computer program product is proposed which, on a program-controlled device, causes the method explained as above to be performed.

A computer program product such as, e.g., a computer program means, can be provided or supplied, for example, as storage medium such as, e.g., memory card, USB stick, CD-ROM, DVD, or also in the form of a downloadable file by a server in a network. This can take place, for example, in a wireless communication network by the transmission of a corresponding file with the computer program product or the computer program means.

The described embodiments and features proposed for the method correspondingly apply to the proposed network.

Further possible implementations of the invention also comprise combinations, not mentioned explicitly, of features or embodiments described before or in the text which follows with respect to the exemplary embodiments. In this context, the expert would also add individual aspects as improvements or additions to the respective basic form of the invention.

Further advantageous embodiments and aspects of the invention are the subject matter of the subclaims and of the exemplary embodiments of the invention described in the text which follows.

### BRIEF DESCRIPTION

Some of the embodiments will be described in detail, with reference to the following figures, wherein like designations denote like members, wherein:

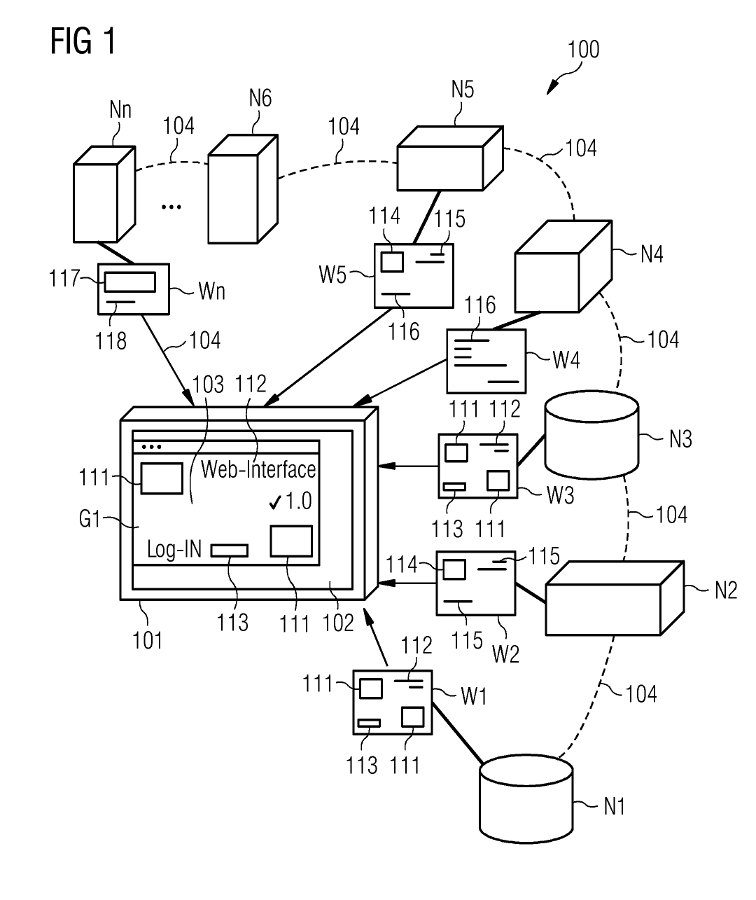

FIG. 1 diagrammatically shows an exemplary embodiment of a network;

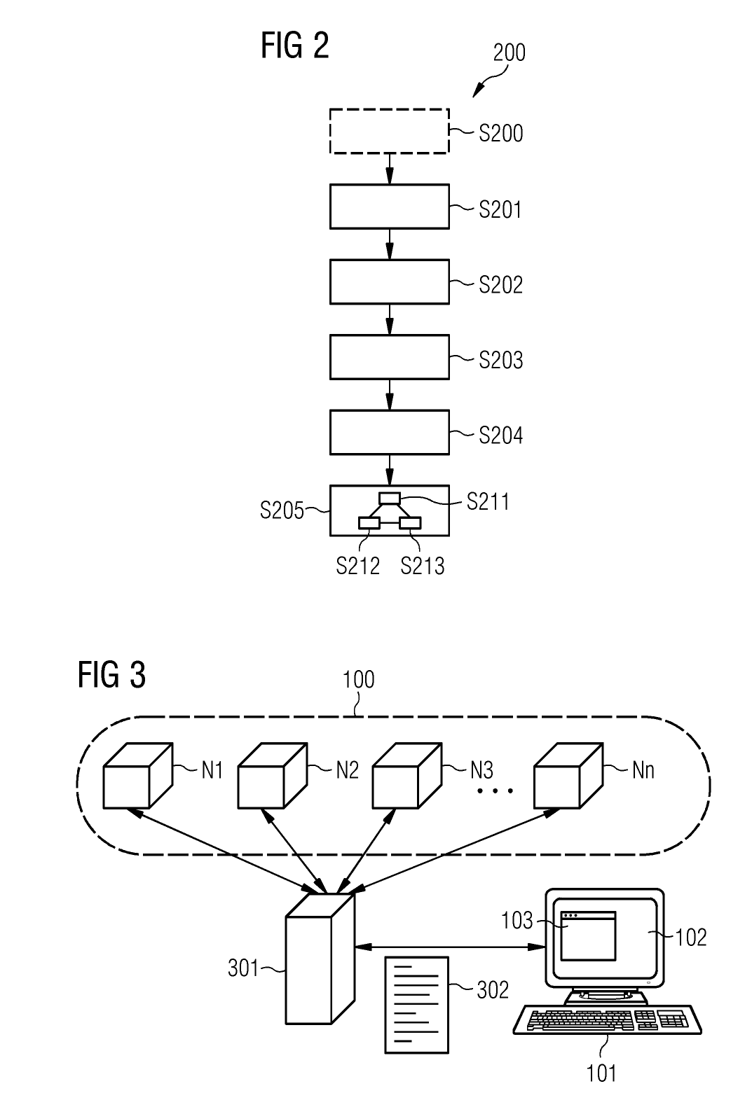

FIG. 2 shows a flowchart of a method for checking network elements in a network;

FIG. 3 diagrammatically shows the acquisition of network addresses of the network elements with the aid of a server device;

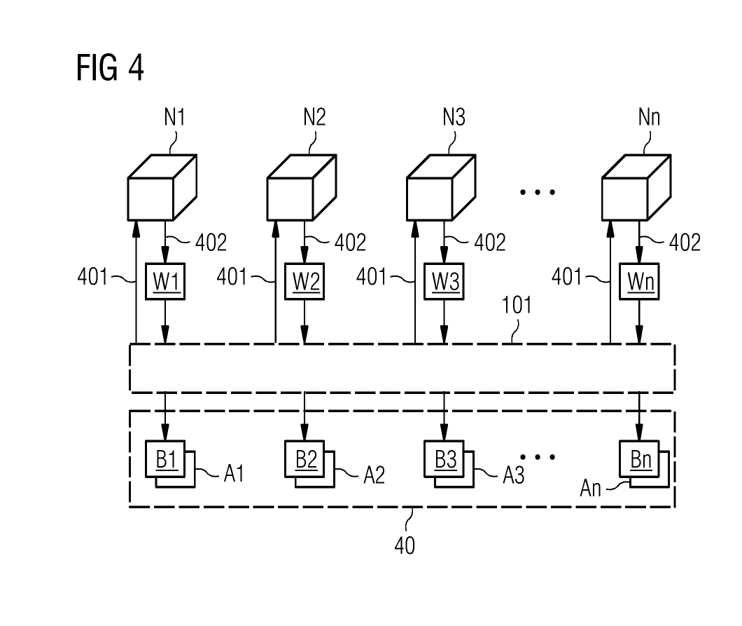

FIG. 4 diagrammatically shows the calling-up of the web interfaces of the network elements from a computing unit;

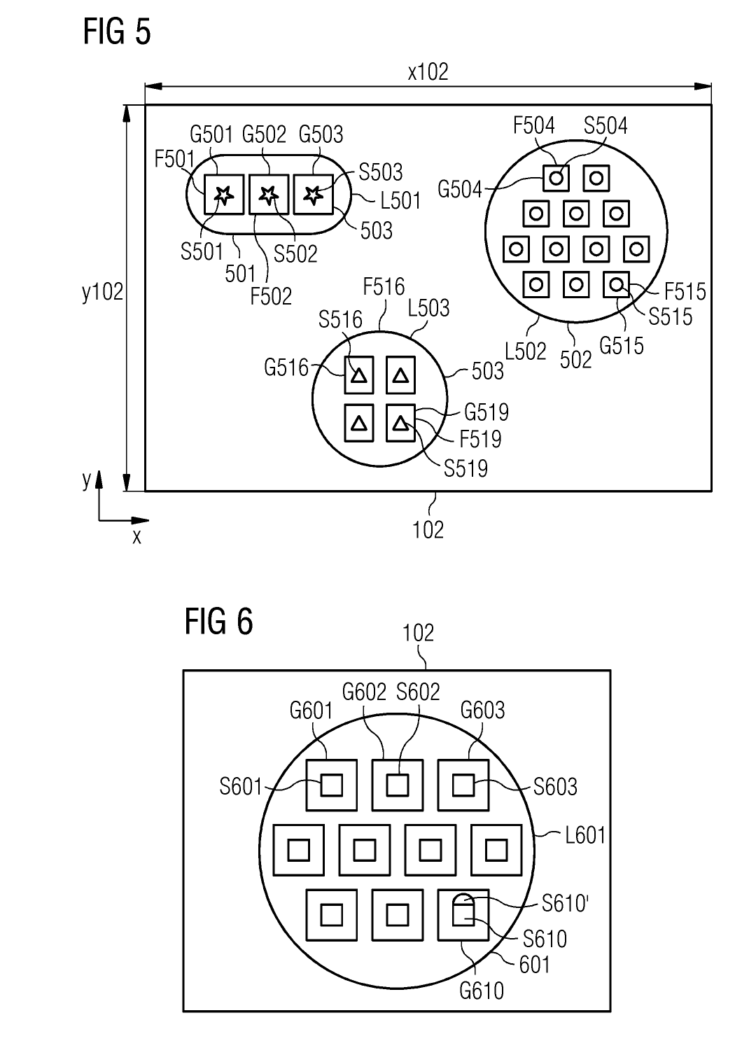

FIG. 5 diagrammatically shows graphical representations of several groups of web interfaces on a screen;

FIG. 6 diagrammatically shows graphical representations of web interfaces on the screen;

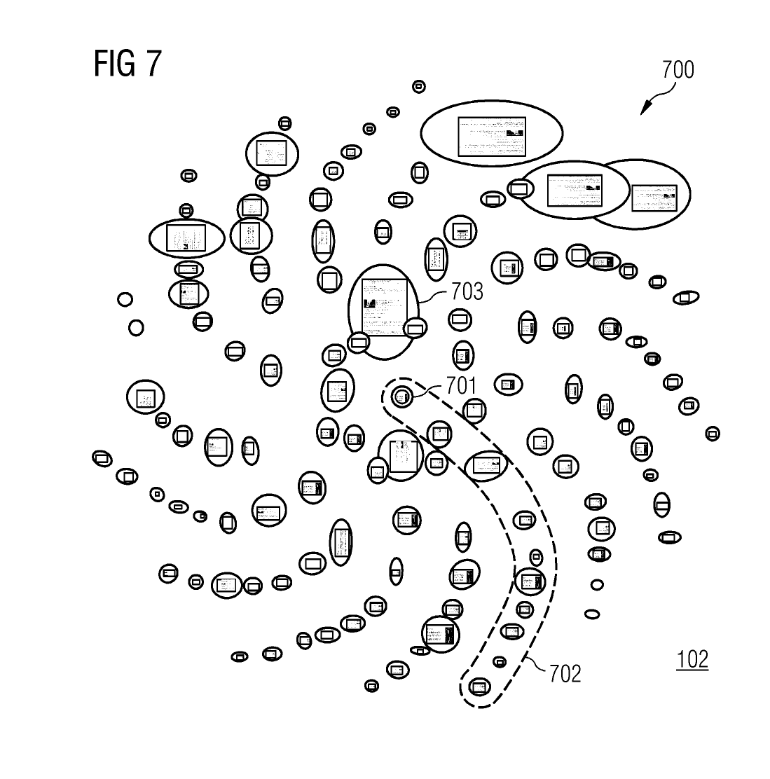

FIG. 7 diagrammatically shows a first exemplary embodiment of an arrangement of groups of web interfaces on a display device; and

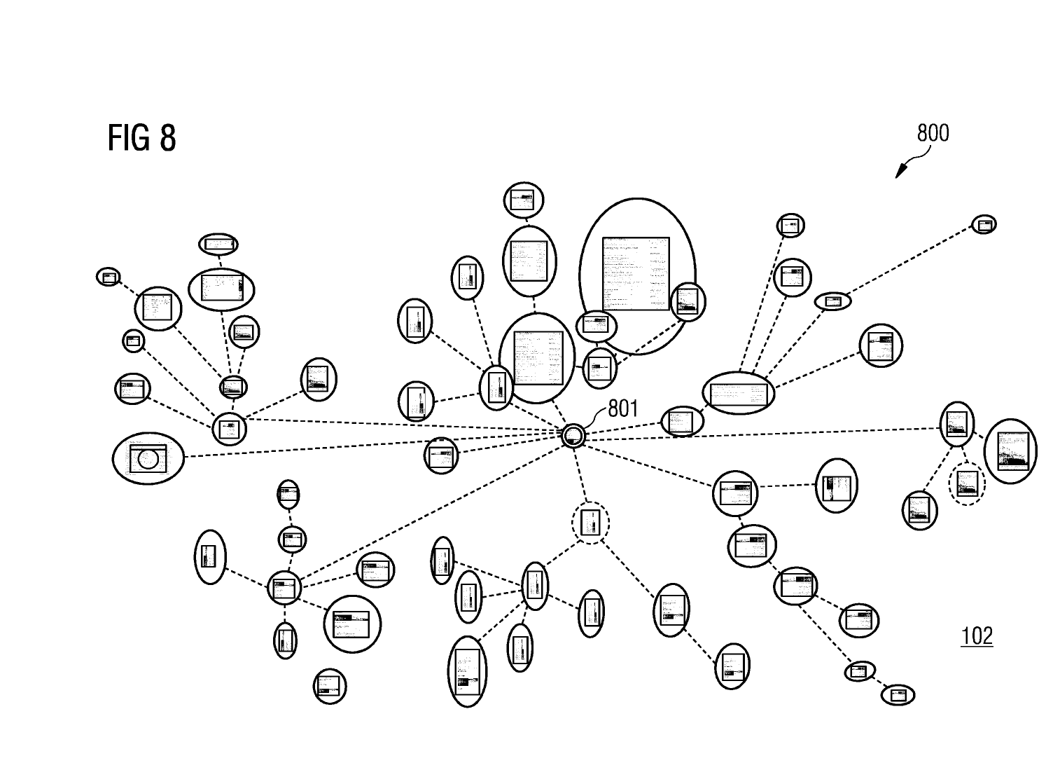

FIG. 8 diagrammatically shows a second exemplary embodiment of an arrangement of groups of web interfaces on a display device.

In the figures, identical or functionally identical elements have been provided with the same reference symbols unless otherwise specified.

FIG. 1 diagrammatically shows an exemplary embodiment of a network 100.

### DETAILED DESCRIPTION

The network 100 is, for example, an intranet of an enterprise or a part of an intranet of an enterprise. In another example, the network 100 is a part of a global network of computers, particularly of the Internet.

The network 100 comprises several network elements N1-Nn which are interconnected with one another, i.e. coupled to one another in such a manner that a data transfer can take place between the network elements N1-Nn. The interconnection of the network elements N1-Nn is shown diagrammatically by dashed lines 104. In particular, the network 100 is part of a larger network which comprises more network elements than the network elements N1-Nn shown in FIG. 1. Alternatively or additionally, at least one of the network elements N1-Nn of the network 100 can comprise a subnetwork having several other interconnected network elements (not shown).

Furthermore, a computing unit 101 is coupled with the network 100 or part of the network 100. The computing unit 101 can interact directly or indirectly with the network elements N1-Nn. When the network elements N1-Nn are called up, the respective web interface W1-Wn is shown graphically on a screen 102 of the computing unit 101.

The network elements N1-Nn can be activated via a respective web interface W1-Wn, wherein at least a part of the network elements N1-Nn, such as, e.g., the network element N6, can be equipped with no web interface. A number of retrievable web interfaces that can be called up of n network elements can thus be smaller than n. The respective web interface W1-Wn is, in particular, a graphical user interface. The web interface W1-Wn provides for activation, configuration and/or modification of the respective network element N1-Nn. The network elements N1, N3 are in each case a database element. The network elements N2, N5 are in each case a control unit of a field device. The network element N4 is a printer. The network element N6 is a computer. The network element Nn is a sensor element.

The web interfaces W1-W5 have in each case several different graphical elements. The web interfaces W1, W3 have in each case two picture elements 111, one text element 112 and one text input field 113. The web interfaces W2, W5 have in each case one picture element 114 and one text element 115. The web interface W4 has several text elements 116. The web interface Wn has a display surface 117 and one text element 118.

The web interfaces W1-Wn are electronically stored locally at the respective network elements N1-Nn. In particular, the web interfaces W1-Wn are stored in the form of a respective HTML source code which, when the network element N1-Nn is addressed, is loaded from a browser device. In particular, the HTML source codes of the web interfaces W1-Wn comprise a respective position of the text and picture elements 111-118 and their content as they are shown diagrammatically in FIG. 1. Storage occurs, in particular, on a local memory device of the computing unit 101.

Based on the respective HTML source code, the web interface W1-Wn called up is displayed in a display window 103 of the browser device. FIG. 1 shows a graphical representation G1 of the web interface W1 of the network element N1 in window 103 of the browser device on the screen 102. The picture elements 111 are in each case positioned at the corners top left and bottom right in window 103 and show a logo of the web interface and an identifying image for the network element N1. The text element 112 specifies the name of the network element N1, the type of the web interface W1 and a version number of the web interface W1. Into the text input field 113, a password and a log-in name can be entered.

With the aid of the graphical representation G1 of the web interface W1, it is possible to access the associated network element N1. By this means, information about the and from the network element N1 can be reproduced on the screen 102, the network element N1 can be configured, operated and activated.

For a security check of the network element N1, the version number of the web interface W1 is checked for actuality in text field 112, the standard password and the standard log-in name are entered into the log-in field in text input field 113 and relevant text parts or picture elements are sought.

FIG. 2 shows a flowchart 200 of a method for checking network elements in a network. In particular, the flowchart 200 shows the method for checking the network elements N1-Nn in the network 100 in FIG. 1.

In a prior step 5200, the network 100 with the network elements N1-Nn as shown in FIG. 1 is provided.

The network 100 optionally comprises a server device 301, as shown diagrammatically in FIG. 3, which is coupled with the network elements N1-Nn of the network 100, and checks connections in network 100. Additionally or as an alternative, the computing unit 101 can check the connections in network 100. The network 100 comprises n network elements N1-Nn. On the basis of the connections at the terminals, the server device 301 creates a network address list 302 of network elements N1-Nn, which are registered in network 100. In this context, at least a part of the network elements N1-Nn can be selectable via a respective web interface W1-Wn.

In a first step S201 of the method for checking the network elements N1-Nn, web interfaces W1-Wn are called up. In particular, the web interfaces W1-Wn can be called up with the aid of the network address list 302 as shown in FIG. 3.

FIG. 4 illustrates that the computing unit 101 addresses the network elements N1-Nn (shown by a respective arrow 401). Network elements N1-Nn return the respective web interface W1-Wn in response as shown by a respective arrow 402.

As a result, the respective web interface W1-Wn is called up. The web interfaces W1-Wn are rendered graphically without being displayed on the screen 102. Instead, a respective image record B1-Bn is generated in a next step S202 (see FIG. 2) for the web interfaces W1-Wn called up, which comprises a respective graphical representation of the web interfaces W1-Wn to be expected. In this context, the image records B1-Bn are created and/or stored in a BMP or JPEG format. The graphical representations are here related to a window of the browser device 103. The image records B1-Bn are stored together with a respective network address A1-An of the network elements N1-Nn in a storage device 403 which is installed locally in the computing unit 101 and/or centrally in the network 100.

In a next step S203, the web interfaces W1-Wn called up are ordered in groups. In this context, a graphical measure of similarity is determined for the graphical representations of the web interfaces W1-Wn called up. The graphical measure of similarity is determined with the aid of the respective image record. For example, the graphical measure of similarity is determined by a pixel-based comparison of graphical representations or a histogram-based method (e.g. histogram-based image segmentation). Preferably, an edge-oriented method is used in which edges of a respective graphical representation are first acquired. The acquired edges are connected to one another so that an area of the graphical representation is enclosed in them. Following this, a distribution of color values in the enclosed area is determined and compared with distributions of the other graphical representations. If the distributions of two graphical representations correspond to one another, the measure of similarity is increased.

Graphical representations of web interfaces W1-Wn, the measure of similarity of which is greater than a predetermined threshold value, are in each case ordered in common groups. Thus, the graphical representations of web interfaces W1, W3 are ordered in a common group. In this context, the graphical representations can differ only in one position or one content of a text element and/or picture element 111-1187. The network elements N1-Nn which are ordered in a common group are preferably electronic systems of the same type, e.g. control units of a respective machine, printer devices or field devices.

In a next step 5204, the graphical representations of web interfaces W1-Wn of at least one of the groups of web interfaces are displayed on the screen 102. The screen 102 has a rectangular screen surface which has dimensions x102, y102 in each case in the x and y direction as shown in FIG. 5. In particular, the graphical representations G501-G519 of web interfaces W1-Wn, which are ordered in the groups, are displayed on the screen 102 of the computing unit 101.

FIG. 5 diagrammatically shows graphical representations G501-G519 of web interfaces W501-W519 called up. The graphical representations G501-G509 are ordered in three groups 501-503 of web interfaces and displayed on the screen 102. The web interfaces W501-W519 are displayed in a respective rectangular window F501-F519, which corresponds to window 103 of the browser device, as shown diagrammatically in FIG. 5. Optical similarity of web interfaces W1-Wn preferably lies in the fact that the respective position and/or the respective content of the text and picture elements 111-118 of the web interfaces W1-Wn exhibit commonalities.

A first group 501 of web interfaces comprises the graphical representations G501-G503 of web interfaces W501-W503. Graphical representations G501-G503 in each case contain a content which is represented by a respective star S501-S503. The contents S501-S503 are optically similar to one another. For example, the graphical representations G501-G503 comprise a respective graphical representation of web interfaces W1, W3.

A second group 502 of web interfaces comprises the graphical representations G504-G515 of web interfaces W504-W515. Graphical representations G504-G515 in each case contain a content which is represented by a respective circle S504-S515. Contents S504-S515 are optically similar to one another. For example, the graphical representations G504-G515 comprise a respective graphical representation of web interfaces W2, W5.

A third group 503 of web interfaces comprises graphical representations G516-G519 of web interfaces W516-W519. Graphical representations G516-G519 in each case contain a content which is represented by a respective triangle S516-S519. Contents S516-S519 are optically similar to one another.

As is shown in FIG. 5, the number of graphical representations G504-G515 is different in the group 501-503 of web interfaces. The first group 501 comprises three graphical representations G501-G503, the second group 502 comprises thirteen graphical representations G504-G515, and the third group 503 comprises four graphical representations G516-G519.

Groups 501-503 are mutually spaced apart, bordered with a respective line L501-L503 and, within a respective border L501-L503, provided with a color which forms a contrast to a background color of the screen surface 102. For example, the color within the borders L501-L503 is white whilst the background color of the screen surface 102 is light blue.

In a next step S205, the graphical representations of web interfaces W1-Wn, which are displayed on the screen 102, are checked. By this means, the respective network elements N1-Nn are checked. Checking the graphical representations comprises recognizing false positives (S211), recognizing potential hazard points (S212) and masking out groups of web interfaces (S213) already checked. In particular, checking comprises accessing network elements N1-Nn with the aid of a respective hyperlink with which the graphical representation of web interfaces W1-Wn is provided. The hyperlinks are generated, in particular, with the aid of the stored network addresses A1-An.

FIG. 6 diagrammatically shows graphical representations G601-G610 of web interfaces W601-W610 on the screen 102.

The graphical representations G601-G610 are allocated to a group 601 which is bordered with a line L601. The content in each of the graphical representations G601-G610 is represented in each case with a quadrangle S601-S610.

The graphical representation G610 has a different content from the remaining graphical representations G601-G609 as is represented by a semicircle S610′ in addition to the quadrangle S610. The graphical representation G610 thus differs from the remaining graphical representations G601-G609. The graphical representation G610 is thus a false positive which is falsely allocated to group 601. This false positive is recognized at first glance of the graphical representations G601-G610 of group 601. Thus, the false positive is recognized more rapidly than the individual web interfaces W601-W610 are called up.

FIG. 7 and FIG. 8 diagrammatically show in each case a first and second exemplary embodiment of an arrangement 700, 800, of groups of web interfaces W1-Wn.

In each group, a particular number of graphical representations of web interfaces W1-Wn is arranged. Each group has an edging, within which the color differs from a color of the background of the screen surface 102.

In FIG. 7, the groups are arranged helically, i.e. extending outward in several uniform curves from a center 701. A curved branch 702 of groups is illustrative of these curves. In this context, some of the groups such as, e.g., combined groups 703, are arranged to overlap in order to emphasize that the graphical representations in these groups, although not allocated to a common group, are optically similar to one another. In the center 701, there is a graphical representation of a web interface which is defined as starting point.

Alternatively or additionally, the groups can be arranged in dependence on a respective measure of similarity with respect to the center 701. In this context, the measure of similarity relates to the graphical representations in the respective group and in the center 701. The greater the measure of similarity between the groups and the center 701, the smaller is a distance between the respective group and the center 701. The groups can be arranged in a predetermined angle spaced apart from one another around a center 701, the predetermined angle being reduced step by step with increasing distance from the center 701. In this manner, a helical arrangement of the groups of web interfaces as in FIG. 7 can be generated.

In FIG. 8, the groups are arranged in dependence on the measure of similarity and displayed coupled to one another with the aid of dashed lines on the screen surface 102. Coherent groups are arranged close to one another and connected to one another with a dashed line. Overall, a mesh of graphical representations, coupled with one another, of the web interfaces is produced which resembles a neuron network.

In the arrangements 700, 800, the different groups can be viewed enlarged with the aid of drag & drop and zooming in and out. Groups already checked by the user can be masked out with a mouse click, e.g. by masking out the edging and the color within the edging of the respective group. It is also conceivable to provide several levels of groups of web interfaces, one of the several levels being displayed optionally in each case.

In particular, the graphical representations of web interfaces W1-Wn in arrangements 700, 800 are provided with a respective hyperlink. The respective web interface W1-Wn is called up with a click on one of the graphical representations. This provides for rapid access to the respective network element N1-Nn.

Although embodiments of the present invention have been described by means of exemplary embodiments, it can be modified in many ways. Further possibilities of arranging the groups of web interfaces are conceivable, e.g. in a tree structure, in a grating structure or star-shaped. It is possible to generate several index images (e.g. thumbnails) of the graphical representation of the respective web interface which are displayed instead of the graphical representations at suitable levels of enlargement.

Although the present embodiments of has been disclosed in the form of preferred embodiments and variations thereon, it will be understood that numerous additional modifications and variations could be made thereto without departing from the scope of the invention.

For the sake of clarity, it is to be understood that the use of ‘a’ or ‘an’ throughout this application does not exclude a plurality, and ‘comprising’ does not exclude other steps or elements.

1. A method for checking network elements in a network which can be activated with the aid of a respective web interface and have a respective network address, comprising:
calling up the web interfaces with the aid of the network addresses;
generating an image record for each web interface called up, the image record comprising a graphical representation of the web interface on a display device;
ordering the web interfaces called up in groups, the graphical representations on the display device of the web interfaces allocated to a respective group having a graphical measure of similarity and the graphical measure of similarity being determined with the aid of the respective image record; and
displaying the graphical representations of the web interfaces of at least one of the groups on a screen having a screen surface,
the graphical representations of the web interfaces being displayed scaled down in such a manner that the graphical representations of the web interfaces of a group are displayed together inside the screen surface on the screen.

2. The method as claimed in claim 1, wherein the graphical representations of the web interfaces), which are ordered in various groups are displayed spaced apart from one another in dependence on the measure of similarity on the screen.

3. The method as claimed in claim 1 wherein the graphical representations of the web interfaces on the screen are provided with a respective hyperlink such that the respective web interface can be called up.

4. The method as claimed in claim 1, wherein the network comprises at least one of a computer network, an intranet and an Internet with a network protocol.

5. The method as claimed in claim 1, wherein the network elements comprise machines, devices, EDP devices, computers, printers, server devices, routers, switches, bridges, firewalls and/or session border controllers.

6. The method as claimed in claim 1, wherein the network also has at least one further network element without respective web interface.

7. The method as claimed in claim 1, wherein the respective image record is stored in a bit map format.

8. The method as claimed in claim 1, also comprising:
executing a pattern recognition method with the graphical representations of the web interfaces.

9. The method as claimed in claim 1, wherein the groups of web interfaces are identified with the aid of a discoloration compared with a background color and/or a border on the screen.

10. The method as claimed in claim 1, also comprising:
optical checking of at least one of the groups of web interfaces, the graphical representations of which are displayed on the screen; and
masking out of an optically checked group) of web interfaces.

11. The method as claimed in claim 1, wherein the graphical representations of the web interfaces contain characters, texts, patterns, images and/or areas of colors different from one another.

12. The method as claimed in claim 1, also comprising:
changing a size of the graphical representation of at least one of the web interfaces on the screen, the size of the graphical representation being determined by a number of pixels comprised by the respective graphical representation on the screen.

13. The method as claimed in claim 1, wherein several groups of web interfaces, the respective measure of similarity of which is higher than a threshold value for the measure of similarity, are displayed in an overlapping manner.

14. A network having a number of network elements which is suited to execute the method as claimed in claim 1.

15. The network as claimed in claim 14, characterized by a computer unit, coupled with the network, for executing the steps of the method.
